(19) United States
(12) Patent Application Publication
(10) Pub. No.: US 2009/0004403 A1
(43) Pub. Date: Jan. 1, 2009

(54) Method of Providing Patterned Embedded Conducive Layer Using Laser Aided Etching of Dielectric Build-Up Layer

(76) Inventor: Yonggang Li, Chandler, AZ (US)

Correspondence Address: INTEL CORPORATION;c/o INTELLEVATE, LLC, P.O. BOX 52050, MINNEAPOLIS, MN, 55402, US

(21) Appl. No.: 11/771,428

(22) Filed: Jun. 29, 2007

(51) Int. Cl. B05D 3/14

(52) U.S. Cl. 427/556

(57) ABSTRACT

A method of providing a patterned conductive layer. The method includes: providing a build-up layer comprising an insulating material; laser irradiating selected portions of the build-up layer according to a predetermined pattern of the patterned conductive layer to be provided, laser irradiating comprising using a laser beam having a photon energy higher than a bonding energy of at least some of the chemical bonds of the insulating material to yield predetermined laser-weakened portions of the build-up layer according to the predetermined pattern; removing the laser-weakened portions of the build-up layer to yield recesses according to the predetermined pattern; and filling the recesses with a conductive material to yield the patterned conductive layer.

### FIELD

Embodiments of the present invention relate generally to the field of patterning conductive layers for microelectronic devices such as for high I/O density substrates.

### BACKGROUND

Conventional processes of patterning conductive layers such as for high I/O density substrates, typically involve the provision of an initial dielectric layer, such as for example, by way of lamination, followed by lithography based semi-additive process. Such process would typically involve electroless seed layer plating, dry film resist lamination, exposure, development, electrolytic metal plating, and dry film resist stripping. The resulting patterned conductive metal layer would be positioned on top of the build-up layer.

Disadvantageously, prior art methods of patterning conductive layers are not well suited to the shrinking feature size and increasing I/O density contemplated for next generation devices. In particular, prior art methods of patterning conductive layers are difficult for line and space features of about 10 microns or less. In addition, such methods typically require extensive process steps, and thus require extended through-put times.

The prior art fails to provide a cost-effective, expedient and reliable method of providing a patterned conductive layer embedded in a dielectric material.

### BRIEF DESCRIPTION OF THE DRAWINGS

FIGS. 1a-1c show three embodiments for laser irradiating;

FIG. 2 shows a build-up layer including laser-weakened portions according to an embodiment; and

FIG. 3 shows a build-up layer including a patterned conductive layer thereon according to an embodiment.

For simplicity and clarity of illustration, elements in the drawings have not necessarily been drawn to scale. For example, the dimensions of some of the elements may be exaggerated relative to other elements for clarity. Where considered appropriate reference numerals have been repeated among the drawings to indicate corresponding or analogous elements.

### DETAILED DESCRIPTION

In the following detailed description a method of providing a patterned conductive layer is described. Reference is made to the accompanying drawings within which are shown, by way of illustration, specific embodiments by which the present invention may be practiced. It is to be understood that other embodiments may exist and that other structural changes may be made without departing from the scope and spirit of the present invention.

The terms on, above, below, and adjacent as used herein refer to the position of one element relative to other elements. As such, a first element disposed on, above, or below a second element may be directly in contact with the second element or it may include one or more intervening elements. In addition, a first element disposed next to or adjacent a second element may be directly in contact with the second element or it may include one or more intervening elements. In addition, in the instant description, figures and/or elements may be referred to in the alternative. In such a case, for example where the description refers to FIGS. X/Y showing an element A/B, what is meant is that FIG. X shows element A and FIG. Y shows element B. In addition, a “layer” as used herein may refer to a layer made of a single material, a layer made of a mixture of different components, a layer made of various sub-layers, each sub-layer also having the same definition of layer as set forth above.

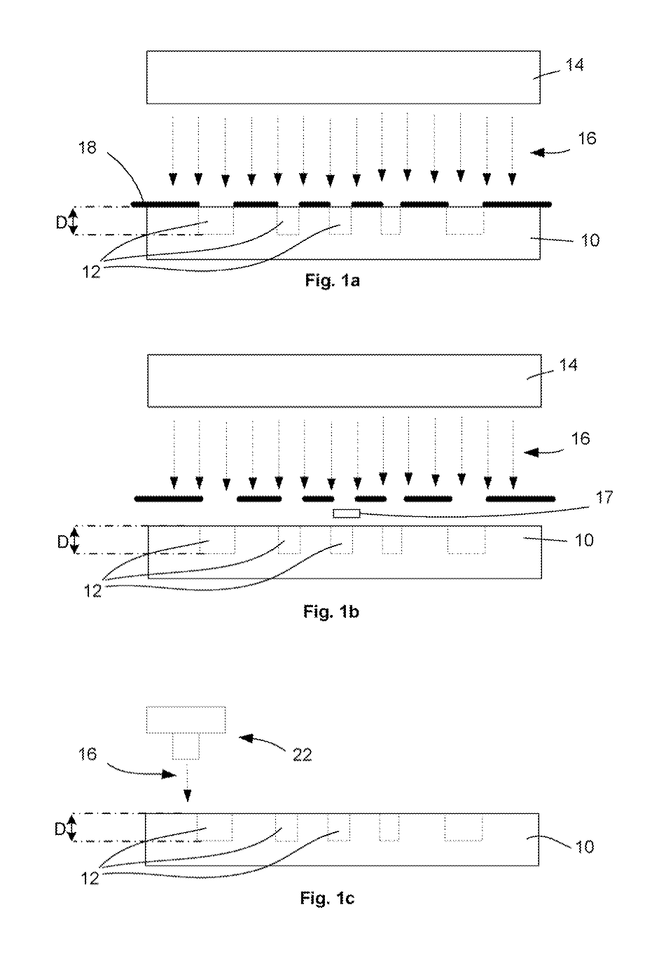

Aspects of this and other embodiments will be discussed herein with respect to FIGS. 1a-5 below. The figures, however, should not be taken to be limiting, as it is intended for the purpose of explanation and understanding.

Referring first to FIGS. 1a-1c embodiments comprise laser irradiating selected portions of a build-up layer according to a predetermined pattern. The build-up layer may include any one of well known dielectric materials, such as, for example, epoxy-resin based dielectric materials (such as, for example, a glass fiber reinforced epoxy resin), glass fiber reinforce polyimide, or bismaleimide-triazine (BT), to name just a few. The predetermined pattern of laser irradiation on the build-up layer according to embodiments corresponds to a predetermined pattern of a patterned conductive layer to be provided into the build-up layer. In the instant description, what is meant by a “patterned conductive layer” is a layer defining, in a side cross-sectional view thereof, a plurality of layer components comprising one or more conductive materials. Thus, according to embodiments, the patterned conductive layer could, for example, encompass a conductive metallization layer (including traces, pads and fiducials and excluding vias) on the one hand, or a layer of conductive vias on the other hand, embedded within the build-up layer. The patterned conductive layer according to embodiments may include a single conductive material, or a number of conductive materials, according to application needs.

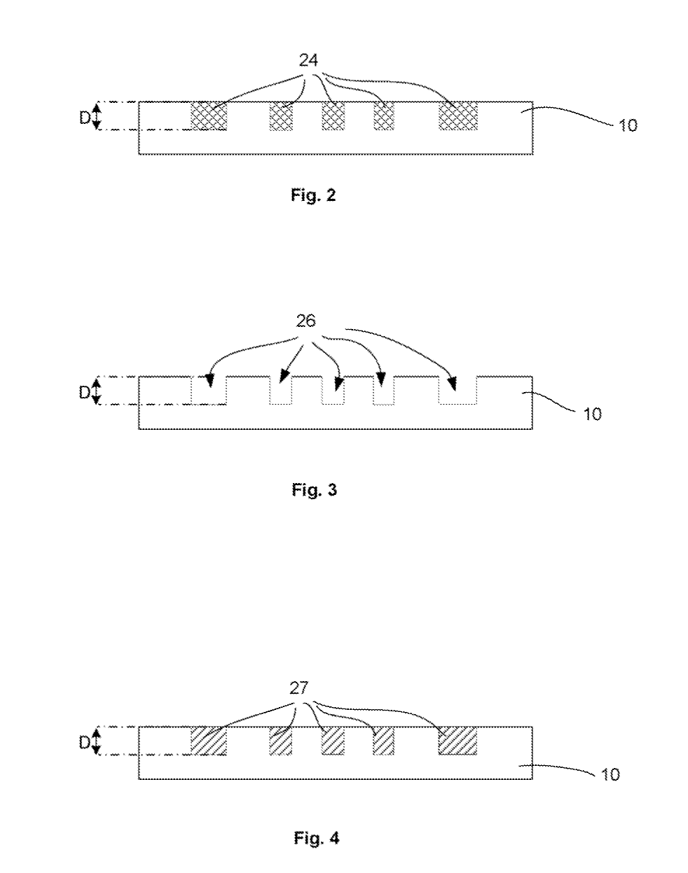

Referring still to FIGS. 1a-1c, a build-up layer 10 may be subjected to laser irradiation on selected portions 12 thereof (shown in broken lines in FIGS. 1a-1c), those selected portions having a pattern of the patterned conductive layer to be provided. Laser irradiation may be effected using a laser source or device 14 emitting laser beams 16 as shown. The laser sources may be selected according to embodiments such that the laser beam they generate has a photon energy that is higher than a bonding energy of at least some of the chemical bonds present within the insulating material of the build-up layer 10. In this way, the laser beam may break some of those chemical bonds in order to generate laser-weakened zones as will be explained in further detail in relation to FIG. 2. Laser irradiation of selected portions may be achieved in any one of well known manners. For example, referring to FIG. 1a, laser irradiating may include, according to one embodiment, providing a contact mask 18 on the build-up layer 10, and laser irradiating the build-up layer 10 through the contact mask 18 using laser beams 16. Referring next to FIG. 1b, laser irradiating may include providing a projection mask 20 above the build-up layer 10 at a distance therefrom and laser irradiating the build-up layer 10 through the projection mask. Laser irradiation would be aided by way of well known projection optics 17 as also shown in FIG. 1b. Referring next to FIG. 1c, laser irradiating may include using direct laser imaging by way of a direct laser imaging device 22 that irradiates the build-up layer 10 at the selected portions 12 using a laser beam 16.

According to one embodiment, laser source 14 emits at a photon energy level between about 2.00 eV and 7.00 eV, and preferably between about 2.25 eV and about 3.65 eV, to break at least some of the chemical bonds present within the insulating material of the build up layer 10. In order for the laser source 14 not to ablate but to merely weaken the insulating material, the laser source may exhibit an average laser fluence less than or equal to about 0.5 J/cm². The laser beam 16 may have a wavelength in the short visible to deep UV region (about 550 nm to about 150 nm). The laser device may include a second and third harmonic Nd: YAG or vanadate lasers having about 532 nm and about 355 nm wavelengths, respectively. Alternatively, the laser device may include a second and third harmonic Nd: YLF laser device having a wavelength of about 527 nm and about 351 nm respectively, or XeCl excimer laser device having a wavelength of about 354 nm, or a XeF excimer laser device having a wavelength of about 308 nm. According to embodiments, the excimer laser devices mentioned above are preferred because of their high pulse energy (about 100 mJ to about 2 Joules generally.

A majority of the chemical bonds in the insulating materials for the build-up layer 10 listed above have a bonding energy ranging from about 1 eV to about 10 eV. Upon irradiation with a laser beam, such as beam 16, the bonded atoms in the selected portions 12 can absorb a photon, and are excited to a higher energy level. If the photon energy is higher than the bonding energy, the atom that absorbed the photon energy can break the chemical bond of the bonded atoms. The fraction of broken bonds as a result of laser irradiation depends on the photon absorption cross-section, the local photon intensity and fluence. The laser irradiation parameters including selection of photon energy may be chosen according to an embodiment to achieve a predetermined depth of absorption of the laser beam 16 by the insulating material of the build-up layer 10. The depth of laser penetration is indicated in the figures, including in FIGS. 1a-1c, by way of dimension D noted on the figures. According to embodiments, the laser photons need to be absorbed into the build-up layer so as to weaken the selected portions 12 to depth ID. According to a preferred embodiment, the depth D may be about 5-15 microns.

Referring next to FIG. 2, laser irradiation of the selected portions 12 leads to predetermined laser-weakened portions 24 on the build-up layer 10. As seen in FIG. 2, laser irradiation of the build-up layer 10 according to embodiments does not ablate all of the material of the selected portions 12 (see FIGS. 1a-1c), but rather breaks at least a number of chemical bonds within those selected portions to yield the laser-weakened portions 24. The laser-weakened portions have the characteristic, among others, that they are etchable at a higher rate than an original material of the build-up layer for the same etch chemistries and etch process parameters.

Referring next to FIG. 3, embodiments include removing the laser-weakened portions 24 to yield recesses 26 which exhibit an embedded pattern according to the predetermined pattern of the patterned conductive layer to be provided. Removal according to an embodiment may include etching, such as, for example etching using one of well known desmearing solutions and desmearing process parameters typically used to desmear laser drilled via openings after laser drilling. An example of such a desmearing solution would include a permanganate agent. The etching solution may be chosen such that it etches little on the original build-up material, but much more on the laser-weakened portions as the chemical bonding in these portions is weakened.

Referring next to FIG. 4, embodiments include filling the recesses 26 with a conductive material 27 to yield a patterned conductive layer 28. According to an embodiment, filling may initially filling the surface of the recesses 26 with a an electroless plated copper seed layer, and thereafter plating on top of the electroless copper seed layer using electrolytic copper plating. Thereafter, a mechanical polishing method, such as, for example, CMP, may be used to limit the copper to the region of the recesses. Other ways of metallizing the recesses would be within the knowledge of one skilled in the art. In the shown embodiment of FIG. 4, the patterned conductive layer 27 includes a conductive metallization layer (shown in cross section).

Although the shown embodiment of FIG. 4 for a patterned conductive layer show only a conductive metallization layer as previously defined, embodiments are not so limited, and include within their scope: as noted above, a patterned conductive layer including a plurality of conductive vias. The vias may be blind or through-vias according to application needs. Thus, in such a case, laser irradiation may be selected to weaken the build-up material to a depth greater than a depth typically associated with a conductive metallization pattern layer.

Advantageously, embodiments provide a method to provide a patterned conductive layer, such as, for example, a conductive metallization layer or a layer of conductive vias, without the use of lithography including dry film resist lamination, exposure, development and stripping, by replacing the lithography process flow with one merely requiring laser irradiation and chemical etching. Additionally, proposed embodiments advantageously generate embedded metal features inside a build-up layer, which enable finer line and spacing than prior art processes, such as fine line and space features below about 10 microns. Additionally, advantageously, embodiments provide laser irradiation which requires significantly tower laser intensity and fluence (about 2 to about 10 times tower depending on the build-up material) than a pure laser ablation process, which advantage can translate into coverage of a much larger area given the same laser budget. Additionally, chemical etching of the laser-weakened portions according to an embodiments may advantageously also serve as a surface cleaning and roughening process for the build-up surface, which process is needed according to the prior art. Thus, embodiments do not add process steps but rather reduce them as compared with the prior art. Additionally: advantageously, embodiments may be used to pattern vias and line and spacing features which may enable improved alignment accuracy compared to prior art laser via and lithography patterning processes. One issue in prior art build-up processes is that laser drilled via alignment and lithography feature alignment interact with each other, with laser alignment representing a build-up alignment constraint. This constraint may be overcome by using the same patterning technique for both the vias and for conductive patterning,

The various embodiments described above have been presented by way of example and not by way of limitation. Having thus described in detail embodiments of the present invention, it is understood that the invention defined by the appended claims is not to be limited by particular details set forth in the above description, as many variations thereof are possible without departing from the spirit or scope thereof.

What is claimed is:

1. A method of providing a patterned conductive layer:
providing a build-up layer comprising an insulating material:
laser irradiating selected portions of the build-up layer according to a predetermined pattern of the patterned conductive layer to be provided laser irradiating comprising using a laser beam having a photon energy higher than a bonding energy of at least some of the chemical bonds of the insulating material to yield predetermined laser-weakened portions of the build-up layer according to the predetermined pattern;
removing the laser-weakened portions of the build-up layer to yield recesses according to the predetermined pattern;
filling the recesses with a conductive material to yield the patterned conductive layer.

2. The method of claim 1, wherein laser irradiating comprises using a laser source having a photon energy between about 2.00 eV to about 7.00 eV.

3. The method of claim 1, wherein laser irradiating comprises using a laser source having an average laser fluence less than or equal to about 0.5 J/cm².

4. The method of claim 1, wherein laser irradiation comprises using a laser source having a wavelength between about 150 nm and about 550 nm.

5. The method of claim 1, wherein laser irradiating comprises using a second and third harmonic Nd: YAG or vanadate laser devices having about 532 nm and about 355 nm wavelengths, respectively,

6. The method of claim 1, wherein laser irradiating comprises using a second and third harmonic Nd: YLF laser device having a wavelength of about 527 nm and about 351 nm respectively.

7. The method of claim 1 wherein laser irradiating comprises using a XeCl excimer laser device having a wavelength of about 354 nm, or a XeF excimer laser device having a wavelength of about 308 nm.

8. The method of claim 1, wherein the insulating material and the laser beam are selected so as to achieve a predetermined depth of absorption of the laser beam by the insulating material.

9. The method of claim 8, wherein the depth of the patterned conductive layer is about 5-15 microns.

10. The method of claim 1, wherein laser irradiating includes:
providing a contact mask on the build-up layer; and
laser irradiating the build-up layer through the contact mask to laser irradiate the selected portions of the build-up layer.

11. The method of claim 1, wherein laser irradiating includes:
providing a projection mask above the build-up layer; and
laser irradiating the build-up layer through the projection mask to laser irradiate the selected portions of the build-up layer.

12. The method of claim 1, wherein laser irradiating includes using laser direct imaging to laser irradiate the selected portions of the buildup layer.

13. The method of claim 1, wherein removing comprises etching the laser-weakened portions.

14. The method of claim 12, wherein etching comprises using a permanganate agent.

15. The method of claim 1, wherein filling comprises providing an electrolessly plated conductive seed layer on the build-up layer and in the recesses, providing an electrolytically plated conductive layer on the electrolessly plated seed layer, and mechanically polishing the electrolytically plated conductive layer.

16. The method of claim 1, wherein the build-up layer comprises one of an epoxy-resin based dielectric material, a glass fiber reinforce polyimide, or a bismaleimide-triazine (BT)

17. The method of claim 15, wherein the build-up layer comprises a glass fiber reinforced epoxy resin.

18. The method of claim 1, wherein the conductive material comprises copper.

19. The method of claim 1 wherein the patterned conductive layer comprises a conductive metallization layer.

20. The method of claim 1, wherein the patterned conductive layer comprises a layer of conductive vias.
